(19) United States
(12) Patent Application Publication
(10) Pub. No.: US 2026/0237223 A1
(43) Pub. Date: Aug. 13, 2026

(54) PARKING ASSISTANCE DEVICE, PARKING ASSISTANCE METHOD, AND PARKING ASSISTANCE PROGRAM

(71) Applicant: AISIN CORPORATION, Kariya, Aichi (JP)

(72) Inventors: Kazutaka HAYAKAWA, Kariya-shi, Aichi-ken (JP); Koki UEDA, Kariya-shi, Aichi-ken (JP); Shoji ASAI, Nagakute-shi, Aichi-ken (JP)

(73) Assignee: AISIN CORPORATION, Kariya, Aichi (JP)

(21) Appl. No.: 19/151,764

(22) PCT Filed: Mar. 22, 2024
(86) PCT No.: PCT/JP2024/011409

§ 371 Date: Jul. 29, 2025

(30) Foreign Application Priority Data
Mar. 22, 2023 (JP) 2023-045962

(51) Int. Cl. G06V 20/58; G06T 7/73; G06V 20/56

(52) U.S. Cl. CPC G06V 20/586; G06T 7/74; G06V 20/588; G06T 2207/30264

(57) ABSTRACT

A parking assistance device including an odometry information acquisition unit acquiring odometry information indicating a positional change amount and an orientation change amount of a vehicle between a parking space and a first position; a road surface region identification unit identifying, based on the odometry information, a road surface region of the parking space in a first image captured from the first position; and a position and orientation estimation unit calculating, by comparing the road surface region in a second image captured from a second position with the road surface region in the first image, relative position and orientation information indicating a positional change amount and an orientation change amount of the vehicle between the first and second positions, and outputs, position and orientation estimation information indicating a position and orientation of the vehicle with respect to the parking space when the vehicle is located at the second position.

### CROSS REFERENCE TO RELATED APPLICATIONS

This application is a National Stage of International Application No. PCT/JP2024/011409 filed Mar. 22, 2024, claiming priority based on Japanese Patent Application No. 2023-045962 filed Mar. 22, 2023, the disclosures of which are incorporated herein by reference in their entireties.

### TECHNICAL FIELD

This disclosure relates to a parking assistance device, a parking assistance method, and a parking assistance program.

### BACKGROUND ART

For example, the following technique is known as a parking assistance device that performs assistance when a vehicle is parked. That is, the parking assistance device described in JP2021-062718A includes a camera attached to a vehicle so as to capture an image of the surroundings of the vehicle, and a control unit that acquires information on a parking lot based on an image, captured by the camera, of the parking lot in which the vehicle is parked, registers the information as parking lot information, and automatically parks the vehicle in the parking lot using the parking lot information.

The control unit is configured to acquire and register the parking lot information when the vehicle is stopped near an entrance of the parking lot, and acquire and register the parking lot information when parking of the vehicle in the parking lot is completed. The control unit is configured to register, as the parking lot information, information on feature points in the parking lot image captured by the camera. According to the parking assistance device, when the vehicle is automatically driven to be parked in the parking lot, a positional relationship between the vehicle and the parking lot can be accurately grasped.

### SUMMARY OF THE DISCLOSURE

### Technical Problem

In the parking assistance device described above, in an environment with good illumination conditions, the position and orientation of the vehicle with respect to a parking space can be estimated by detecting feature points (for example, an object or a corner of a pattern) from the image and associating the feature points between the images using a luminance pattern around the feature points. However, in an environment with poor illumination conditions, such as an outdoor parking lot at night, it is difficult to accurately estimate the position and orientation of the vehicle because there are many erroneous correspondences between feature points.

Here, if a region in which a plane in the image appears can be specified, the position and orientation of the vehicle can be estimated. Examples of a method of specifying a region in which a plane appears include a method such as semantic segmentation. However, these methods require a large amount of computation.

The technique of this disclosure has been made in view of the above circumstances, and an object thereof is to provide a parking assistance device, a parking assistance method, and a parking assistance program capable of estimating a position and an orientation of a vehicle with respect to a parking space with a smaller amount of computation than a method such as semantic segmentation in an environment with poor illumination conditions.

### Solution to Problem

A first aspect according to a technique of this disclosure provides a parking assistance device including an odometry information acquisition unit configured to acquire odometry information indicating a positional change amount and an orientation change amount of a vehicle between a parking space and a first position outside the parking space, a road surface region identification unit configured to identify, based on the odometry information, a road surface region of the parking space in a first image captured from the first position by an in-vehicle camera mounted on the vehicle, and a position and orientation estimation unit configured to calculate, by comparing the road surface region in a second image captured by the in-vehicle camera from a second position different from the first position outside the parking space with the road surface region in the first image, relative position and orientation information indicating a positional change amount and an orientation change amount of the vehicle between the first position and the second position, and output, based on the odometry information and the relative position and orientation information, position and orientation estimation information indicating a position and orientation of the vehicle with respect to the parking space when the vehicle is located at the second position.

The parking assistance device according to a second aspect according to the technique of this disclosure is directed to the parking assistance device according to the first aspect, in which the position and orientation estimation unit calculates a homography matrix between the first image and the second image based on a luminance value of a pixel included in the road surface region in the first image and a luminance value of a pixel included in the road surface region in the second image, and decomposes the homography matrix to calculate the relative position and orientation information.

The parking assistance device according to a third aspect according to the technique of this disclosure is directed to the parking assistance device according to the first aspect or the second aspect, and further includes a parking control unit configured to perform control to park the vehicle in the parking space from the second position based on the position and orientation estimation information.

A fourth aspect according to the technique of this disclosure provides a parking assistance method including an odometry information acquisition step of acquiring odometry information indicating a positional change amount and an orientation change amount of a vehicle between a parking space and a first position outside the parking space, a road surface region identification step of identifying, based on the odometry information, a road surface region of the parking space in a first image captured from the first position by an in-vehicle camera mounted on the vehicle, and a position and orientation estimation step of calculating, by comparing the road surface region in a second image captured by the in-vehicle camera from a second position different from the first position outside the parking space with the road surface region in the first image, relative position and orientation information indicating a positional change amount and an orientation change amount of the vehicle between the first position and the second position, and outputting, based on the odometry information and the relative position and orientation information, position and orientation estimation information indicating a position and orientation of the vehicle with respect to the parking space when the vehicle is located at the second position.

A fifth aspect according to the technique of this disclosure provides a parking assistance program causing a computer to execute an odometry information acquisition step of acquiring odometry information indicating a positional change amount and an orientation change amount of a vehicle between a parking space and a first position outside the parking space, a road surface region identification step of identifying, based on the odometry information, a road surface region of the parking space in a first image captured from the first position by an in-vehicle camera mounted on the vehicle, and a position and orientation estimation step of calculating, by comparing the road surface region in a second image captured by the in-vehicle camera from a second position different from the first position outside the parking space with the road surface region in the first image, relative position and orientation information indicating a positional change amount and an orientation change amount of the vehicle between the first position and the second position, and outputting, based on the odometry information and the relative position and orientation information, position and orientation estimation information indicating a position and orientation of the vehicle with respect to the parking space when the vehicle is located at the second position.

### Advantageous Effects of Various Aspects of the Disclosure

The technique of this disclosure can estimate position and orientation of a vehicle with respect to a parking space with a smaller amount of computation compared with a method such as semantic segmentation in an environment with poor illumination conditions.

### BRIEF DESCRIPTION OF DRAWINGS

FIG. 1 is a block diagram illustrating an example of a configuration of a parking assistance system according to an embodiment.

FIG. 2 is a block diagram illustrating an example of a functional configuration of a parking assistance device according to the embodiment.

FIG. 3 is a plan view illustrating an example of a positional relationship between a parking space and a first position outside the parking space.

FIG. 4 is a diagram illustrating an example of a first image captured by an in-vehicle camera from the first position.

FIG. 5 is a plan view illustrating a positional relationship between a camera coordinate system of each in-vehicle camera and a vehicle coordinate system.

FIG. 6 is a diagram illustrating an example of a positional relationship between an image coordinate system and end points of a road surface region in the first image.

FIG. 7 is a plan view illustrating an example of a positional relationship among a parking space, the first position, and a second position.

FIG. 8 is a diagram illustrating an example of a second image captured by the in-vehicle camera from the second position.

FIG. 9 is a flowchart illustrating an example of a flow of parking assistance processing according to the embodiment.

FIG. 10 is a flowchart illustrating an example of a flow of homography matrix optimum value calculation processing according to the embodiment.

### DESCRIPTION OF EMBODIMENTS

Hereinafter, an example of an embodiment for carrying out the technique of this disclosure will be described in detail with reference to the drawings. Components and processing having the same operation, action, and function are denoted by the same reference numerals throughout the drawings, and redundant description may be omitted as appropriate. Each drawing is merely schematically illustrated to the extent that the technique of this disclosure can be sufficiently understood. Therefore, the technique of this disclosure is not limited to the illustrated examples. In the present embodiment, a description of a configuration that is not directly related to the technique of this disclosure or a known configuration may be omitted.

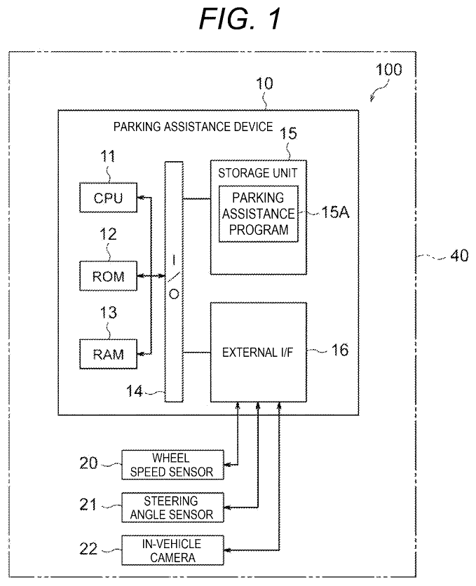

FIG. 1 is a block diagram illustrating an example of a configuration of a parking assistance system 100 according to the present embodiment. The parking assistance system 100 according to the present embodiment is mounted on a vehicle 40. The vehicle 40 may be any vehicle such as a passenger automobile. The parking assistance system 100 is a system that performs assistance when parking the vehicle 40, and includes a parking assistance device 10, a wheel speed sensor 20, a steering angle sensor 21, and an in-vehicle camera 22.

The in-vehicle camera 22 is installed in the vehicle 40 and captures an image of surroundings of the vehicle 40. An installation location of the in-vehicle camera 22 in the vehicle 40 is not particularly limited as long as it is disposed in a state where an image of the road surface can be captured. The in-vehicle camera 22 is, for example, a monocular camera, but is not limited thereto, and may be a stereo camera or the like.

The in-vehicle camera 22 is disposed, for example, such that an optical axis of the in-vehicle camera 22 faces slightly downward from a horizontal direction. The in-vehicle camera 22 is communicably connected to the parking assistance device 10, and transmits a captured image to the parking assistance device 10. One in-vehicle camera 22 may be mounted on the vehicle 40, or a plurality of in-vehicle cameras 22 may be mounted on the vehicle 40. Hereinafter, an example in which a plurality of in-vehicle cameras 22 (for example, four in-vehicle cameras 22 installed on the front, rear, left, and right of a vehicle body) are mounted on the vehicle 40 will be described.

The wheel speed sensor 20 measures a wheel speed of a wheel provided in the vehicle 40. The wheel speed sensor 20 transmits data of the measured wheel speed to the parking assistance device 10. An encoder provided for the wheel may be used as the wheel speed sensor 20. When the vehicle 40 is a vehicle including a driving motor, such as a hybrid vehicle, an encoder provided in the driving motor may be used as the wheel speed sensor 20.

The steering angle sensor 21 measures a steering angle of the vehicle 40. The steering angle sensor 21 transmits data of the measured steering angle to the parking assistance device 10.

The parking assistance device 10 may be implemented by a part of an electronic control unit (ECU) that is a vehicle control computer, or may be implemented by an in-vehicle computer different from the ECU.

The parking assistance device 10 includes a central processing unit (CPU) 11, a read only memory (ROM) 12, a random access memory (RAM) 13, an input/output interface (I/O) 14, a storage unit 15, and an external interface (external I/F) 16.

The CPU 11, the ROM 12, the RAM 13, and the I/O 14 are connected to one another via a bus. Functional units including the storage unit 15 and the external I/F 16 are connected to the I/O 14. These functional units can mutually communicate with the CPU 11 via the I/O 14.

The CPU 11, the ROM 12, the RAM 13, and the I/O 14 constitute a control unit. The control unit may be configured as a sub-control unit that controls a part of the operation of the parking assistance device 10, or may be configured as a part of a main control unit that controls the entire operation of the parking assistance device 10.

For example, an integrated circuit such as a large scale integration (LSI) or an integrated circuit (IC) chipset may be used for some or all of the blocks of the control unit. An individual circuit may be used for each of the blocks, or a circuit in which some or all of the blocks are integrated may be used. The blocks may be integrally provided, or some of the blocks may be separately provided. In each of the blocks, a part thereof may be separately provided. The integration of the control unit is not limited to LSI, and a dedicated circuit or a general-purpose processor may be used.

Examples of the storage unit 15 include a hard disk drive (HDD), a solid state drive (SSD), and a flash memory. The storage unit 15 stores a parking assistance program 15A according to the present embodiment. The parking assistance program 15A may be stored in the ROM 12.

The parking assistance program 15A may be installed in advance, for example, in the parking assistance device 10. In addition, the parking assistance program 15A may be implemented by being stored in a non-volatile storage medium or distributed via a network and being appropriately installed in the parking assistance device 10. Examples of the non-volatile storage medium include a compact disc read only memory (CD-ROM), a magneto-optical disk, an HDD, a digital versatile disc read only memory (DVD-ROM), a flash memory, and a memory card.

The external I/F 16 is an interface for communicably connecting to each of the wheel speed sensor 20, the steering angle sensor 21, and the in-vehicle camera 22.

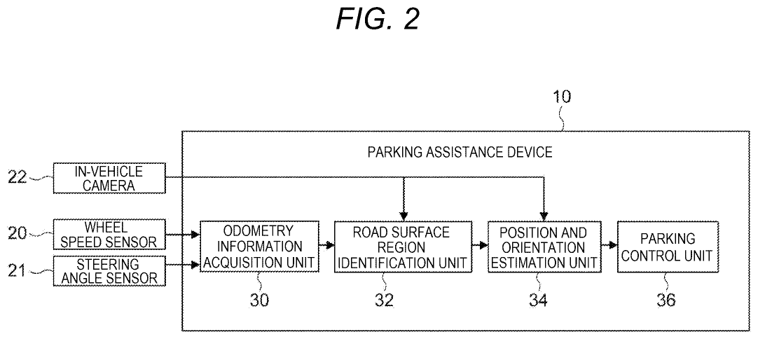

The CPU 11 of the parking assistance device 10 according to the present embodiment functions as each unit illustrated in FIG. 2 by writing the parking assistance program 15A stored in the storage unit 15 into the RAM 13 and executing the parking assistance program 15A.

FIG. 2 is a block diagram illustrating an example of a functional configuration of the parking assistance device 10 according to the present embodiment. The CPU 11 of the parking assistance device 10 according to the present embodiment functions as an odometry information acquisition unit 30, a road surface region identification unit 32, a position and orientation estimation unit 34, and a parking control unit 36.

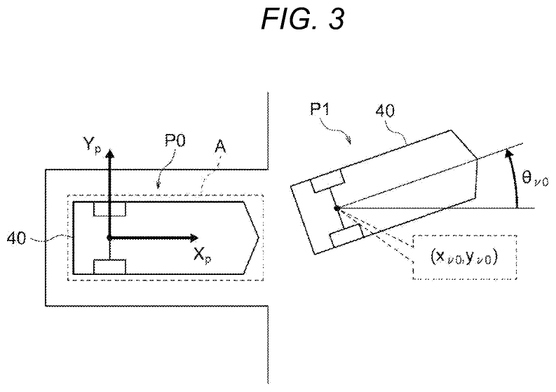

FIG. 3 is a plan view illustrating an example of a positional relationship between a parking space P0 and a first position P1. The first position P1 is any position outside the parking space P0. As an example, the first position P1 is a position near an exit of the parking space P0. The first position P1 may be a position where the vehicle 40 will enter the parking space P0 or a position where the vehicle 40 has left the parking space P0. The vehicle 40 may be manually driven by a driver or may be autonomously driven by an autonomous driving system.

The odometry information acquisition unit 30 acquires odometry information by acquiring measurement values measured by the wheel speed sensor 20 and the steering angle sensor 21 when the vehicle 40 moves between the parking space P0 and the first position P1, and calculating the odometry information based on the acquired measurement values.

The measurement values obtained by the wheel speed sensor 20 and the steering angle sensor 21 are examples of travel history information of the vehicle 40 obtained when the vehicle 40 moves between the parking space P0 and the first position P1. The odometry information is information indicating a positional change amount and an orientation change amount of the vehicle 40 between the parking space P0 and the first position P1.

When an origin of a parking lot coordinate system (Xₚ-Yₚ coordinate system) is set at a center of a rear wheel axis of the vehicle 40 parked in the parking space P0, the odometry information is represented by a position of the rear wheel axis center (xᵥ₀, yᵥ₀) and a yaw angle θᵥ₀. However, the Xₚ axis is a coordinate axis extending in a front-rear direction of the vehicle 40 parked in the parking space P0, and the Yₚ axis is a coordinate axis extending in a width direction of the vehicle 40 parked in the parking space P0. Hereinafter, the odometry information may be referred to as odometry information (xᵥ₀, yᵥ₀, θᵥ₀).

A calculation formula of the odometry information (xᵥ₀, yᵥ₀, θᵥ₀) is described as follows. Hereinafter, the position of the rear wheel axis center with respect to the origin of the parking lot coordinate system (Xₚ-Yₚ coordinate system) is referred to as a vehicle position (xᵥ, yᵥ).

Here, a sampling period is represented by T[s], and various state quantities in the k-th sampling are represented by ⋅(k). Hereinafter, as an example, a case of vehicle leaving will be described. It is assumed that the vehicle 40 is parked in the parking space P0 when k=0.

The vehicle speed V(k) [m/s] is calculated based on a wheel speed ωₜ (k) [rad/s] measured by the wheel speed sensor 20 according to the following formula using a radius Rₜ [m] of a wheel (tire).

$$V ( k ) = {R}_{f} {ω}_{f} ( k ) \qquad [ Math . 1 ]$$

Based on a steering wheel angle θₕ (k) [rad] measured by the steering angle sensor 21, a front wheel steering angle θ_{f} (k) [rad] is calculated according to the following formula using a steering gear ratio Gₛ.

$${θ}_{f} ( k ) = {θ}_{h} ( k ) / {G}_{s} \qquad [ Math . 2 ]$$

Based on the vehicle speed V(k) and the front wheel steering angle θ_{f} (k), a yaw rate ωᵥ (k) [rad/s] is calculated according to the following formula using a wheelbase L_{wb} [m].

$${ω}_{v} ( k ) = V ( k ) {θ}_{f} ( k ) / {L}_{wb} \qquad [ Math . 3 ]$$

A yaw angle θᵥ (k) [rad] is calculated based on the yaw rate ωᵥ (k) according to the following formula. Note that θᵥ (0)=0.

$${θ}_{v} ( k ) = {θ}_{v} ( k - 1 ) + T {ω}_{v} ( k ) \qquad [ Math . 4 ]$$

A vehicle position (xᵥ (k), yᵥ (k)) is calculated based on the vehicle speed V(k) and the yaw angle θᵥ (k) according to the following formula. Note that xᵥ (0)=0 and yᵥ (0)=0.

$${x}_{v} ( k ) = {x}_{v} ( k - 1 ) + TV ( k ) cos {θ}_{v} ( k ) \qquad [ Math . 5 ]$$

$${y}_{v} ( k ) = {y}_{v} ( k - 1 ) + TV ( k ) sin {θ}_{v} ( k )$$

The odometry information when the vehicle 40 is located at the first position P1 (xᵥ (k), yᵥ (k), θᵥ (k)) is represented by (xᵥ₀, yᵥ₀, θᵥ₀).

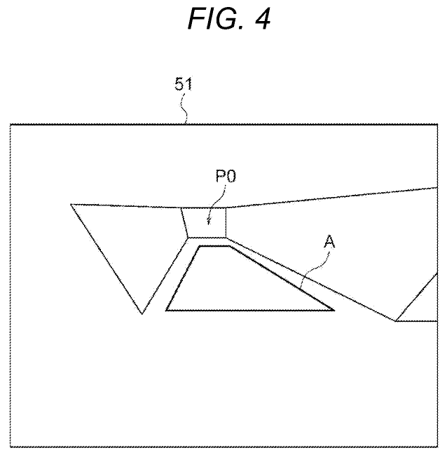

FIG. 4 is a diagram illustrating an example of a first image 51 captured by the in-vehicle camera 22 from the first position P1. The road surface region identification unit 32 acquires the first image 51 captured from the first position P1 by the in-vehicle camera 22, and identifies a road surface region A of the parking space P0 in the acquired first image 51 based on the odometry information (xᵥ₀, yᵥ₀, θᵥ₀).

Here, the road surface region A of the parking space P0 in the real space is treated as a rectangle defined by the entire length and the entire width of the vehicle 40. The first image 51 may be an image captured by any in-vehicle camera 22 among the plurality of in-vehicle cameras 22 mounted on the vehicle 40 (that is, four in-vehicle cameras 22 respectively installed on the front, rear, left, and right of the vehicle body).

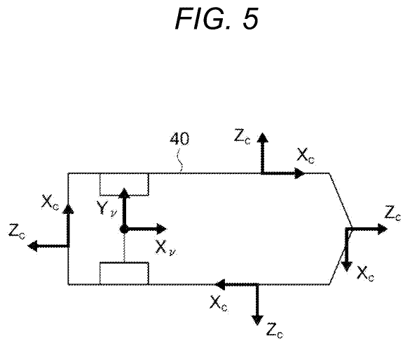

FIG. 5 is a plan view illustrating a positional relationship between a camera coordinate system (X_{c}-Z_{c} coordinate system) of each in-vehicle camera 22 and a vehicle coordinate system (Xᵥ-Yᵥ coordinate system). The vehicle coordinate system (Xᵥ-Yᵥ coordinate system) is set at the rear wheel axis center. In the following description, it is assumed that the relative position and the relative orientation of the camera coordinate system (X_{c}-Z_{c} coordinate system) of each in-vehicle camera 22 with respect to the vehicle coordinate system (Xᵥ-Yᵥ coordinate system) are obtained in advance. Therefore, the road surface region A of the parking space P0 in the first image 51 can be identified using the relative position and the relative orientation of the camera coordinate system (X_{c}-Z_{c} coordinate system) with respect to the vehicle coordinate system (Xᵥ-Yᵥ coordinate system) and the odometry information (xᵥ₀, yᵥ₀, θᵥ₀). As described above, calculation resources can be reduced, and costs can be reduced by identifying the road surface region A in the first image 51 based on the odometry information without using a method with a large amount of computation, such as semantic segmentation.

The calculation formula of the road surface region A in the first image 51 will be described below. Here, for the vehicle 40, the total length is Lᵥ [m], the total width is Wᵥ [m], and the distance from the rear wheel axis center to the rear end of the vehicle body is Lᵣ [m]. When the four end points of the road surface region A in the parking lot coordinate system (Xₚ-Yₚ coordinate system) illustrated in FIG. 3 are defined as end points P₁, P₂, P₃, and P₄, the positions of the end point P₁, P₂, P₃, and P₄ are represented by vectors p_{1_p}, p_{2_p}, p_{3_p}, and p_{4_p} in the following formulas. T represents transposition.

$${p}_{1 \_ p} = {[ - {L}_{r} , - 0.5 {W}_{v} , 0 ]}^{T} \qquad [ Math . 6 ]$$

$${p}_{2 \_ p} = {[ - {L}_{r} , 0.5 {W}_{v} , 0 ]}^{T}$$

$${p}_{3 \_ p} = {[ {L}_{v} - {L}_{r} , 0.5 {W}_{v} , 0 ]}^{T}$$

$${p}_{4 \_ p} = {[ {L}_{v} - {L}_{r} , - 0.5 {W}_{v} , 0 ]}^{T}$$

When the position of an end point Pi (i=1, 2, 3, 4) in the vehicle coordinate system (Xᵥ-Yᵥ coordinate system) is assumed to be a vector p_{i_v}, the vector p_{i_v} is calculated according to the following formula.

$${p}_{i \_ v} = {R}_{v 0}^{T} ( {p}_{i \_ p} - {t}_{v 0} ) \qquad [ Math . 7 ]$$

$${R}_{v 0} = [ \begin{matrix}cos {θ}_{v 0} & - sin {θ}_{v 0} & 0 \\ sin {θ}_{v 0} & cos {θ}_{v 0} & 0 \\ 0 & 0 & 1\end{matrix} ] , {t}_{v 0} = [ \begin{matrix}{x}_{v 0} \\ {y}_{v 0} \\ 0\end{matrix} ]$$

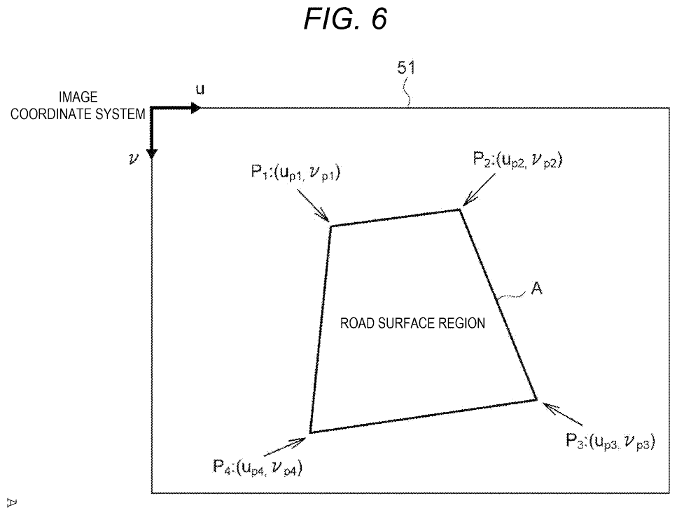

FIG. 6 is a diagram illustrating an example of a positional relationship between an image coordinate system (u-v coordinate system) and each of end points P₁, P₂, P₃, and P₄ of the road surface region A in the first image 51. An origin of the image coordinate system (u-v coordinate system) is set to one end point (as an example, the upper left end point) among the plurality of end points of the first image 51. The u coordinate axis is a coordinate axis extending in the horizontal direction of the first image 51, and the v coordinate axis is a coordinate axis extending in the vertical direction of the first image 51. The position of each of the end points P₁, P₂, P₃, and P₄ of the road surface region A in the first image 51 is represented by (Uₚ₁, Vₚ₁), (Uₚ₂, Vₚ₂), (Uₚ₃, Vₚ₃), and (Uₚ₄, Vₚ₄).

From P_{i_v}=[x_{i_v}, y_{i_v}, 0]^{T}, the position (Uₚ₁, Vₚ₁) of each end point Pᵢ (i=1, 2, 3, 4) in the image coordinate system (u-v coordinate system) illustrated in FIG. 6 is calculated according to the following formula using an internal parameter matrix K and an external parameter matrix Tₑₓₜ of the in-vehicle camera 22. Here, f is the focal length of the in-vehicle camera 22, (cₓ, c_{y}) are the center coordinates of the first image 51, and T₁₁ to T₃₄ are an external parameter matrix, which are all known.

$$[ \begin{matrix}{u}_{pi} \\ {v}_{pi} \\ 1\end{matrix} ] = {KT}_{ext} [ \begin{matrix}{x}_{i \_ v} \\ {y}_{i \_ v} \\ 0 \\ 1\end{matrix} ] \qquad [ Math . 8 ]$$

$$K = [ \begin{matrix}f & 0 & {c}_{x} & 0 \\ 0 & f & {c}_{y} & 0 \\ 0 & 0 & 1 & 0\end{matrix} ] , {T}_{ext} = [ \begin{matrix}{T}_{11} & {T}_{12} & {T}_{13} & {T}_{14} \\ {T}_{21} & {T}_{22} & {T}_{23} & {T}_{24} \\ {T}_{31} & {T}_{32} & {T}_{33} & {T}_{34} \\ 0 & 0 & 0 & 1\end{matrix} ]$$

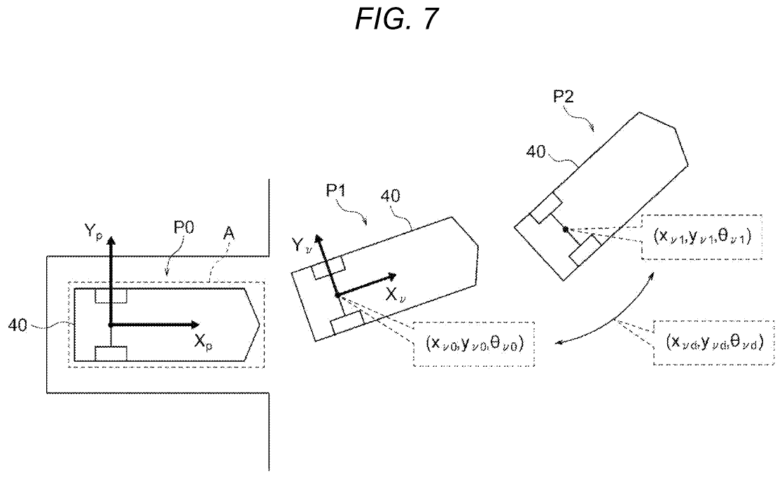

FIG. 7 is a plan view illustrating an example of a positional relationship among the parking space P0, the first position P1, and a second position P2. The second position P2 is, for example, a parking start position when the vehicle 40 is to be automatically parked in the parking space P0. The second position P2 is any position different from the first position P1 outside the parking space P0. As an example, the second position P2 is a position opposite to the parking space P0 relative to the first position P1. In other words, the first position P1 corresponds to an intermediate position between the second position P2 and the parking space P0.

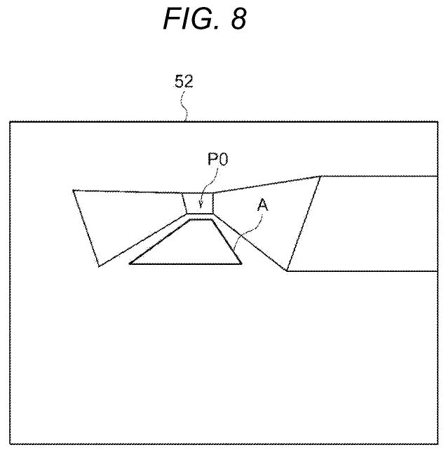

FIG. 8 is a diagram illustrating an example of a second image 52 captured by the in-vehicle camera 22 from the second position P2. When the vehicle 40 is automatically parked in the parking space P0 from the second position P2, the position and orientation estimation unit 34 acquires the second image 52 captured by the in-vehicle camera 22 from the second position P2. The second image 52 may be an image captured by any in-vehicle camera 22 among the plurality of in-vehicle cameras 22 mounted on the vehicle 40 (that is, four in-vehicle cameras 22 respectively installed on the front, rear, left, and right of the vehicle body). The second image 52 may be an image captured by the in-vehicle camera 22 different from the in-vehicle camera 22 that has captured the first image 51.

Subsequently, the position and orientation estimation unit 34 calculates relative position and orientation information indicating a positional change amount and an orientation change amount of the vehicle 40 between the first position P1 and the second position P2 by comparing the road surface region A in the second image 52 with the road surface region A in the first image 51. The relative position and orientation information is represented by (x_{vd}, y_{vd}, θ_{vd}) with reference to the origin of the vehicle coordinate system (Xᵥ-Yᵥ coordinate system) when the vehicle 40 is located at the first position P1. Hereinafter, the relative position and orientation information may be referred to as relative position and orientation information (x_{vd}, y_{vd}, and θ_{vd}).

Specifically, the position and orientation estimation unit 34 calculates the relative position and orientation information (x_{vd}, y_{vd}, θ_{vd}) in the following manner. First, the position and orientation estimation unit 34 calculates a homography matrix between the first image 51 and the second image 52 based on luminance values of pixels included in the road surface region A in the first image 51 and luminance values of pixels included in the road surface region A in the second image 52. For example, the homography matrix between the first image 51 and the second image 52 is determined by searching for a region in which a deviation between the luminance values of the pixels included in the road surface region A in the first image 51 and the luminance values of the pixels included in the road surface region A in the second image 52 is minimized. Note that homography refers to projection of a certain plane onto another plane using projective transformation.

Subsequently, the position and orientation estimation unit 34 decomposes the homography matrix to calculate the relative position and orientation information (x_{vd}, y_{vd}, θ_{vd}). In this case, the position and orientation estimation unit 34 obtains the relative position and the relative orientation of the in-vehicle camera 22 between the first position P1 and the second position P2 by decomposing the homography matrix. Next, the position and orientation estimation unit 34 converts the relative position and the relative orientation of the in-vehicle camera 22 between the first position P1 and the second position P2 into the relative position and the relative orientation of the vehicle 40 using the relative position and the relative orientation of the camera coordinate system with respect to the vehicle coordinate system, thereby obtaining the relative position and orientation information (x_{vd}, y_{vd}, θ_{vd}).

Then, the position and orientation estimation unit 34 estimates and outputs, based on the odometry information (xᵥ₀, yᵥ₀, θᵥ₀) and the relative position and orientation information (x_{vd}, y_{vd}, θ_{vd}), position and orientation estimation information (xᵥ₁, yᵥ₁, θᵥ₁) indicating the position and orientation of the vehicle 40 with respect to the parking space P0 when the vehicle 40 is located at the second position P2. As described above, when the relative position and orientation information (x_{vd}, y_{vd}, θ_{vd}) is obtained, the luminance values of the pixels included in the road surface region A in the first image 51 and the second image 52 are used, and therefore, it is possible to estimate the position and orientation of the vehicle 40 with respect to the parking space P0 even in an environment in which the illumination condition of the parking space P0 is bad.

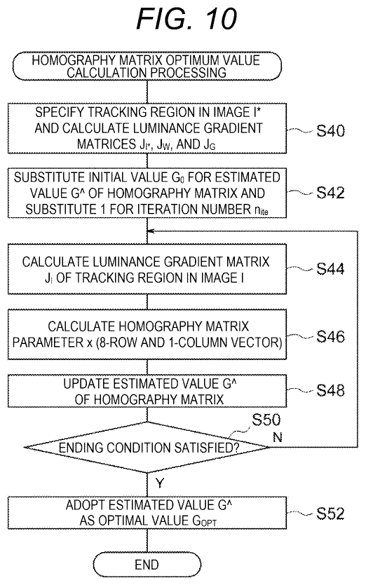

The calculation formula for the position and orientation estimation information (xᵥ₁, yᵥ₁, θᵥ₁) will be described below. First, an initial value Go of the homography matrix between the first image 51 and the second image 52 is set to a unit matrix with three rows and three columns, and an optimum value Gₒₚₜ of the homography matrix is calculated. A calculation procedure for determining the optimum value Gₒₚₜ of the homography matrix will be described below with reference to FIG. 10. Next, the optimum value Gₒₚₜ of the homography matrix is decomposed as in the following formula.

$${G}_{opt} = K ( {R}_{est} + \frac{{t}_{est} {n}_{est}^{T}}{h} ) {K}^{- 1} \qquad [ Math . 9 ]$$

Here, K is an internal parameter matrix of the in-vehicle camera 22, Rₑₛₜ is a rotation matrix (estimated value) representing an orientation change amount of the in-vehicle camera 22 with respect to the camera coordinate system (X_{c}-Z_{c} coordinate system), tₑₛₜ is a translation vector (estimated value) representing a positional change amount of the in-vehicle camera 22 with respect to the camera coordinate system, nₑₛₜ is a road surface normal vector (estimated value) with respect to the camera coordinate system, and h is an installation height (measurement value in advance) of the in-vehicle camera 22 from the road surface.

A method of decomposing the optimum value Gₒₚₜ of the homography matrix is disclosed in the following document.
E. Malis, et al., “Deeper understanding of the homography decomposition for vision-based control,” Research Report, RR-6303, INRIA, 2007.

Next, a rotation matrix R_{vd} representing the orientation change amount of the vehicle 40 and a translation vector t_{vd} representing the positional change amount of the vehicle 40 with respect to the vehicle coordinate system (Xᵥ-Yᵥ coordinate system) of the first position P1 illustrated in FIG. 7 are calculated according to the following formulas.

$$[ \begin{matrix}{R}_{vd} & {t}_{vd} \\ 0 & 1\end{matrix} ] = {T}_{ext}^{- 1} [ \begin{matrix}{R}_{est} & {t}_{est} \\ 0 & 1\end{matrix} ] {T}_{ext} \qquad [ Math . 10 ]$$

When the relative position and orientation information of the second position P2 represented by the vehicle coordinate system (Xᵥ-Yᵥ coordinate system) of the first position P1 illustrated in FIG. 7 is represented by (x_{vd}, y_{vd}, θ_{vd}), the first row and first column component of the translation vector t_{vd} corresponds to x_{vd}, and the second row and first column component of the translation vector t_{vd} corresponds to y_{vd}. In addition, θ_{vd} is calculated according to the following formula. Here, R₁₂ is the first row and second column component of R_{vd}, and R₂₂ is the second row and second column component of R_{vd}.

$${θ}_{vd} = arctan \frac{- {R}_{12}}{{R}_{22}} \qquad [ Math . 11 ]$$

Based on the odometry information (Xᵥ₀, yᵥ₀, θᵥ₀) and the relative position and orientation information (x_{vd}, y_{vd}, θ_{vd}), the position and orientation estimation information (xᵥ₁, yᵥ₁, θᵥ₁) of the second position P2 represented by the parking lot coordinate system (Xₚ-Yₚ coordinate system) of the parking space P0 illustrated in FIG. 7 is calculated according to the following formula.

$$[ \begin{matrix}{x}_{v 1} \\ {y}_{v 1}\end{matrix} ] = [ \begin{matrix}cos {θ}_{v 0} & - sin {θ}_{v 0} \\ sin {θ}_{v 0} & cos {θ}_{v 0}\end{matrix} ] [ \begin{matrix}{x}_{vd} \\ {y}_{vd}\end{matrix} ] + [ \begin{matrix}{x}_{v 0} \\ {y}_{v 0}\end{matrix} ] \qquad [ Math . 12 ]$$

$${θ}_{v 1} = {θ}_{v 0} + {θ}_{vd}$$

The parking control unit 36 performs control to park the vehicle 40 in the parking space P0 from the second position P2 based on the position and orientation estimation information (xᵥ₁, yᵥ₁, θᵥ₁). In this case, the position and orientation of the vehicle 40 with respect to the parking space P0 can be estimated even in an environment with poor illumination conditions, and therefore, the vehicle 40 can be automatically parked in the parking space P0 from the second position P2.

Next, the operation of the parking assistance device 10 according to the present embodiment will be described.

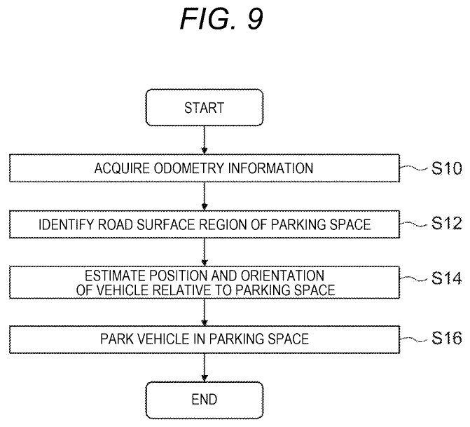

FIG. 9 is a flowchart showing an example of a flow of parking assistance processing executed by the parking assistance program 15A according to the present embodiment.

First, when the parking assistance device 10 receives an instruction to start the parking assistance processing, the parking assistance program 15A is activated by the CPU 11 to execute the following steps.

In step S10, the CPU 11 acquires, from the storage unit 15, the odometry information (xᵥ₀, yᵥ₀, θᵥ₀) calculated based on the measurement values measured by the wheel speed sensor 20 and the steering angle sensor 21 when the vehicle 40 moves between the parking space P0 and the first position P1. Step S10 is an example of an odometry information acquisition step according to the technique of this disclosure.

In step S12, the CPU 11 acquires the first image 51 captured from the first position P1 by the in-vehicle camera 22 from the storage unit 15, and identifies the road surface region A of the parking space P0 in the acquired first image 51 based on the odometry information (xᵥ₀, yᵥ₀, θᵥ₀). Step S12 is an example of a road surface region identification step according to the technique of this disclosure.

In step S14, the CPU 11 acquires the second image 52 captured by the in-vehicle camera 22 from the second position P2 when the vehicle 40 to be parked is automatically parked in the parking space P0 from the second position P2. Subsequently, the position and orientation estimation unit 34 calculates the relative position and orientation information (x_{vd}, y_{vd}, θ_{vd}) indicating the positional change amount and the orientation change amount of the vehicle 40 between the first position P1 and the second position P2 by comparing the road surface region A in the second image 52 and the road surface region A in the first image 51.

Specifically, first, the position and orientation estimation unit 34 calculates a homography matrix between the first image 51 and the second image 52 based on the luminance values of the pixels included in the road surface region A in the first image 51 and the luminance values of the pixels included in the road surface region A in the second image 52. Subsequently, the position and orientation estimation unit 34 decomposes the homography matrix to calculate the relative position and orientation information (x_{vd}, y_{vd}, θ_{vd}).

Then, the position and orientation estimation unit 34 estimates and outputs, based on the odometry information (xᵥ₀, yᵥ₀, θᵥ₀) and the relative position and orientation information (x_{vd}, y_{vd}, θ_{vd}), position and orientation estimation information (xᵥ₁, yᵥ₁, θᵥ₁) indicating the position and orientation of the vehicle 40 with respect to the parking space P0 when the vehicle 40 is located at the second position P2. Step S14 is an example of a position and orientation estimation step according to the technique of this disclosure.

In step S16, the CPU 11 performs control to park the vehicle 40 in the parking space P0 from the second position P2 based on the position and orientation estimation information (xᵥ₁, yᵥ₁, θᵥ₁). Step S16 is an example of a parking control step according to the technique of this disclosure.

The above-described method described as the operation of the parking assistance device 10 according to the present embodiment is an example of a parking assistance method according to the technique of this disclosure.

Next, a calculation procedure for determining the optimum value Gₒₚₜ of the homography matrix will be described.

FIG. 10 is a flowchart illustrating an example of a flow of homography matrix optimum value calculation processing according to the present embodiment. Here, a number i (i=1, 2 to n) is assigned to all pixels (the number of pixels is n) in the road surface region A determined by the end points P₁, P₂, P₃, and P₄ in the first image 51 illustrated in FIG. 6. Although not particularly illustrated, similarly to the first image 51, a number i (i=1, 2 to n) is assigned to all pixels in the road surface region A determined by the end point P₁, P₂, P₃, and P₄ in the second image 52.

In step S40, the CPU 11 specifies a tracking region (having the same meaning as the road surface region A in the first image 51) for an image I* (having the same meaning as the first image 51), and calculates a luminance gradient matrix J_{I*} and a Jacobian matrix J_{W}, J_{G}.

Specifically, the luminance gradient matrix J_{I*} is calculated based on the luminance (value of 0 to 255) of each pixel of the tracking region in the image I* according to the following formula.

$${J}_{{I}^{*}} = [ \begin{matrix}{J}_{{I}^{*} 1} \\ {J}_{{I}^{*} 2} \\ ⋮ \\ {J}_{{I}^{*} n}\end{matrix} ] \qquad [ Math . 13 ]$$

Here, J_{I*i} (i=1, 2 to n) is expressed according to the following formula. J_{I*ui} represents a luminance gradient in the horizontal direction of the i-th pixel, and J_{I*vi} represents a luminance gradient in the vertical direction of the i-th pixel.

$${J}_{I * i} = [ {J}_{I * ui} {J}_{I * vi} 0 ] ( i = 1 ∼ n ) \qquad [ Math . 14 ]$$

The Jacobian matrix J_{W} is calculated based on the coordinates of each pixel in the tracking region in the image I* according to the following formula.

$${J}_{w} = [ \begin{matrix}{J}_{w 1} \\ {J}_{w 2} \\ ⋮ \\ {J}_{wn}\end{matrix} ] \qquad [ Math . 15 ]$$

The coordinates of each pixel in the tracking region are expressed according to the following formula.

$${p}_{i}^{*} = [ \begin{matrix}{u}_{i}^{*} & {v}_{i}^{*} & {0 ]}^{T}\end{matrix} \qquad [ Math . 16 ]$$

At this time, J_{Wi} is expressed according to the following formula.

$${J}_{wi} = [ \begin{matrix}{p}_{i}^{*} & 0 & - {u}_{i}^{*} {p}_{i}^{*} \\ 0 & {p}_{i}^{*} & - {v}_{i}^{*} {p}_{i}^{*} \\ 0 & 0 & 0\end{matrix} ] \qquad [ Math . 17 ]$$

A Jacobian matrix J_{G} is calculated based on a basis Aᵢ (i=1 to 8) of the Lie algebra according to the following formula.

$${J}_{G} = [ \begin{matrix}{[ {A}_{1} ]}_{V} & {[ {A}_{2} ]}_{V} & … & {[ {A}_{8} ]}_{V} ]\end{matrix} \qquad [ Math . 18 ]$$

Here, [Aᵢ]ᵥ is a vector with nine rows and one column rearranged for each row as expressed according to the following formula.

$${A}_{1} = [ \begin{matrix}0 & 0 & 1 \\ 0 & 0 & 0 \\ 0 & 0 & 0\end{matrix} ] {A}_{2} = [ \begin{matrix}0 & 0 & 0 \\ 0 & 0 & 1 \\ 0 & 0 & 0\end{matrix} ] {A}_{3} = [ \begin{matrix}0 & 1 & 0 \\ 0 & 0 & 0 \\ 0 & 0 & 0\end{matrix} ] {A}_{4} = [ \begin{matrix}0 & 0 & 0 \\ 1 & 0 & 0 \\ 0 & 0 & 0\end{matrix} ] \qquad [ Math . 19 ]$$

$${A}_{5} = [ \begin{matrix}1 & 0 & 0 \\ 0 & - 1 & 0 \\ 0 & 0 & 0\end{matrix} ] {A}_{6} = [ \begin{matrix}0 & 0 & 0 \\ 0 & - 1 & 0 \\ 0 & 0 & 1\end{matrix} ] {A}_{7} = [ \begin{matrix}0 & 0 & 0 \\ 0 & 0 & 0 \\ 1 & 0 & 0\end{matrix} ] {A}_{8} = [ \begin{matrix}0 & 0 & 0 \\ 0 & 0 & 0 \\ 0 & 1 & 0\end{matrix} ]$$

In step S42, the CPU 11 substitutes the initial value G₀ (a unit matrix) for an estimated value G\hat{ }(\hat{ } is directly above G, the same applies below) of the homography matrix, and substitutes 1 for the number of iterations (repetitions) nᵢₜₑ.

In step S44, the CPU 11 calculates the luminance gradient matrix J_{I} of the tracking region in the image I (having the same meaning as the second image 52).

Specifically, the CPU 11 calculates the coordinates in the image I according to the following formula.

$$[ \begin{matrix}{u}_{i}^{′} \\ {v}_{i}^{′} \\ w\end{matrix} ] = \hat{G} {p}_{i}^{*} , {u}_{i} = \frac{{u}_{i}^{′}}{w} , {v}_{i} = \frac{{v}_{i}^{′}}{w} \qquad [ Math . 20 ]$$

Here, a coordinate pi in the image I is expressed according to the following formula.

$${p}_{i} = [ \begin{matrix}{u}_{i} & {v}_{i} & {0 ]}^{T} ( i = 1 ∼ n )\end{matrix} \qquad [ Math . 21 ]$$

The luminance gradient matrix J_{I} is calculated based on the luminance of each pixel of the tracking region in the image I according to the following formula.

$${J}_{I} = [ \begin{matrix}{J}_{I 1} \\ {J}_{I 2} \\ ⋮ \\ {J}_{In}\end{matrix} ] \qquad [ Math . 22 ]$$

Here, J_{Ii} is expressed according to the following formula. J_{Iui} represents the luminance gradient in the horizontal direction of the i-th pixel, and J_{Ivi} represents the luminance gradient in the vertical direction of the i-th pixel.

$${J}_{Ii} = [ \begin{matrix}{J}_{Iui} & {J}_{Ivi} & 0 ] ( i = 1 ∼ n )\end{matrix} \qquad [ Math . 23 ]$$

In step S46, the CPU 11 calculates a parameter x of the homography matrix (vector with eight rows and one column).

Specifically, the CPU 11 calculates the parameter x according to the following formula.

$$x = - {J}_{esm}^{+} y \qquad [ Math . 24 ]$$

Here, Jₑₛₘ is a Jacobian matrix and is calculated according to the following formula.

$${J}_{esm} = \frac{1}{2} ( {J}_{I} + {J}_{I}^{*} ) {J}_{w} {J}_{G} \qquad [ Math . 25 ]$$

On the other hand, y is a luminance difference vector and is expressed according to the following formula.

$$y = [ \begin{matrix}{y}_{1} & {y}_{2} & … & {{y}_{n} ]}^{T}\end{matrix} \qquad [ Math . 26 ]$$

Here, yi is calculated based on the luminance Iᵢ of the i-th pixel of the image I and the luminance Iᵢ* of the i-th pixel of the image I* according to the following formula.

$${y}_{i} = {I}_{i} - {I}_{i}^{*} \qquad [ Math . 27 ]$$

In step S48, the CPU 11 updates the estimated value G\hat{ } of the homography matrix according to the following formula.

$$A ( x ) = {\sum }_{i = 1}^{8} {x}_{i} {A}_{i} \qquad [ Math . 28 ]$$

$$G = exp ( A ( x ) )$$

Then, the CPU 11 sets the G as a new G\hat{ }.

In step S50, it is determined whether the CPU 11 satisfies an ending condition, that is, whether an iteration (repetition) is necessary. When the ending condition is satisfied, that is, when it is determined that the iteration (repetition) is unnecessary (in the case of affirmative determination), the processing proceeds to step S52, and when the ending condition is not satisfied, that is, when it is determined that the iteration (repetition) is necessary (in the case of negative determination), the processing returns to step S44 and the processing is repeated.

Specifically, when the root mean square of the current luminance difference is y_{curr}, y_{curr} is expressed according to the following formula.

$${y}_{curr} = \sqrt{\frac{1}{\dot{n}} {\sum }_{i = 1}^{n} {y}_{i}^{2}} \qquad [ Math . 29 ]$$

Here, it is assumed that the upper limit number of iterations is nₘₐₓ (for example, 100), and the threshold for convergence determination is ε (for example, 10⁻⁵).

When nᵢₜₑ=1, the root mean square of the current luminance difference y_{curr} is substituted for the root mean square of the previous luminance difference yₚᵣₑᵥ, 1 is added to the number of iterations nᵢₜₑ, and the processing returns to step S44.

In the case of 1<nᵢₜₑ<nₘₐₓ, if yₚᵣₑᵥ−y_{curr}>ε, it is determined that convergence has not occurred, the root mean square of the current luminance difference y_{curr} is substituted for the root mean square of the previous luminance difference yₚᵣₑᵥ, 1 is added to the number of iterations nᵢₜₑ, and the processing returns to step S44. On the other hand, if yₚᵣₑᵥ−y_{curr}≤ε, it is determined that convergence has occurred, and the processing proceeds to step S52.

When nᵢₜₑ=nₘₐₓ, the processing proceeds to step S52.

In step S52, the CPU 11 adopts the estimated value G\hat{ } of the homography matrix as the optimum value G_{OPT}, and ends the processing.

As described above in detail, according to the present embodiment, the CPU 11 acquires the odometry information (xᵥ₀, yᵥ₀, θᵥ₀) indicating a positional change amount and an orientation change amount of the vehicle 40 between the parking space P0 and the first position P1, and identifies, based on the odometry information (xᵥ₀, yᵥ₀, θᵥ₀), the road surface region A of the parking space P0 in the first image 51 captured from the first position P1 by the in-vehicle camera 22. Therefore, the road surface region A of the parking space P0 in the first image 51 can be identified based on the odometry information (xᵥ₀, yᵥ₀, θᵥ₀) without using a method with a large amount of computation, such as semantic segmentation, and therefore, calculation resources can be reduced, and costs can be reduced.

Further, the CPU 11 compares the road surface region A in the second image 52 captured by the in-vehicle camera 22 from the second position P2 outside the parking space P0 with the road surface region A in the first image 51 to calculate the relative position and orientation information (x_{vd}, y_{vd}, θ_{vd}) indicating a positional change amount and an orientation change amount of the vehicle 40 between the first position P1 and the second position P2. Here, as an example, the CPU 11 calculates a homography matrix between the first image 51 and the second image 52 based on luminance values of pixels included in the road surface region A in the first image 51 and luminance values of pixels included in the road surface region A in the second image 52, and decomposes the homography matrix to calculate the relative position and orientation information (x_{vd}, y_{vd}, θ_{vd}).

Then, the CPU 11 estimates, based on the odometry information (xᵥ₀, yᵥ₀, θᵥ₀) and the relative position and orientation information (x_{vd}, y_{vd}, θ_{vd}), the position and orientation estimation information (xᵥ₁, yᵥ₁, θᵥ₁) indicating the position and orientation of the vehicle 40 with respect to the parking space P0 when the vehicle 40 is located at the second position P2. Therefore, when the relative position and orientation information (x_{vd}, y_{vd}, θ_{vd}) is obtained, the luminance values of the pixels included in the road surface region A in the first image 51 and the second image 52 are used, and therefore, it is possible to estimate the position and orientation of the vehicle 40 with respect to the parking space P0 even in an environment in which the illumination condition of the parking space P0 is bad.

The CPU 11 performs control to park the vehicle 40 in the parking space P0 from the second position P2 based on the position and orientation estimation information (xᵥ₁, yᵥ₁, θᵥ₁). Therefore, the position and orientation of the vehicle 40 with respect to the parking space P0 can be estimated even in an environment with poor illumination conditions, and therefore, the vehicle 40 can be automatically parked in the parking space P0 from the second position P2.

In the above embodiment, as an example, the CPU 11 calculates a homography matrix between the first image 51 and the second image 52 based on luminance values of pixels included in the road surface region A in the first image 51 and luminance values of pixels included in the road surface region A in the second image 52, and decomposes the homography matrix to calculate the relative position and orientation information (x_{vd}, y_{vd}, θ_{vd}). However, the CPU 11 may calculate the relative position and orientation information (x_{vd}, y_{vd}, θ_{vd}) by comparing the road surface region A in the second image 52 and the road surface region A in the first image 51 according to a method other than a calculation method using the homography matrix.

Further, in the above embodiment, the CPU 11 acquires the measurement values measured by the wheel speed sensor 20 and the steering angle sensor 21 when the vehicle 40 moves between the parking space P0 and the first position P1, and calculates the odometry information (xᵥ₀, yᵥ₀, θᵥ₀) based on the acquired measurement values. However, the CPU 11 may acquire, for example, a measurement value measured by a sensor installed in a place other than the vehicle 40, and calculate odometry information (xᵥ₀, yᵥ₀, θᵥ₀) based on the acquired measurement value. In addition, the CPU 11 may acquire the odometry information (xᵥ₀, yᵥ₀, θᵥ₀) input to the parking assistance device 10 from the outside of the vehicle.

In the above embodiment, the processor refers to a processor in a broad sense, and may be a general-purpose processor such as a CPU, or may include a dedicated processor such as a graphics processing unit (GPU), an application specific integrated circuit (ASIC), or a field programmable gate array (FPGA).

The operations of the processor in the above-described embodiments may be performed not only by a single processor, but also by a plurality of processors located at physically separate positions working together. The order of operations of the processor is not limited to the order described in the above-described embodiments, and may be changed as appropriate.

The parking assistance device according to the embodiment has been exemplified and described above. The embodiment may be in the form of a program for causing a computer to execute the functions of the units provided in the parking assistance device. The embodiment may be in the form of a computer-readable non-transitory storage medium storing these programs.

In addition, the configuration of the parking assistance device described in the above-described embodiment is an example, and may be changed according to a situation without departing from the gist.

The processing flow of the program described in the above-described embodiment is also an example. Therefore, in the above-described embodiment, unnecessary steps may be deleted, new steps may be added, or the processing order may be changed without departing from the gist.

In the above-described embodiment, the case where the processing according to the embodiment is implemented by a software configuration using a computer by executing a program has been described, but the disclosure is not limited thereto. The embodiment may be implemented by, for example, a hardware configuration or a combination of a hardware configuration and a software configuration.

All documents, patent applications, and technical standards described in the present description are incorporated by reference in the present description to the same extent as in the case where the individual documents, patent applications, and technical standards are specifically and individually described to be incorporated by reference. The entire disclosure of Japanese Application No. 2023-045962 filed on Mar. 22, 2023 is incorporated herein by reference.

1. A parking assistance device comprising:
an odometry information acquisition unit configured to acquire odometry information indicating a positional change amount and an orientation change amount of a vehicle between a parking space and a first position outside the parking space;
a road surface region identification unit configured to identify, based on the odometry information, a road surface region of the parking space in a first image captured from the first position by an in-vehicle camera mounted on the vehicle; and
a position and orientation estimation unit configured to calculate, by comparing the road surface region in a second image captured by the in-vehicle camera from a second position different from the first position outside the parking space with the road surface region in the first image, relative position and orientation information indicating a positional change amount and an orientation change amount of the vehicle between the first position and the second position, and output, based on the odometry information and the relative position and orientation information, position and orientation estimation information indicating a position and orientation of the vehicle with respect to the parking space when the vehicle is located at the second position.

2. The parking assistance device according to claim 1, wherein
the position and orientation estimation unit calculates a homography matrix between the first image and the second image based on a luminance value of a pixel included in the road surface region in the first image and a luminance value of a pixel included in the road surface region in the second image, and decomposes the homography matrix to calculate the relative position and orientation information.

3. The parking assistance device according to claim 1, further comprising:
a parking control unit configured to perform control to park the vehicle in the parking space from the second position based on the position and orientation estimation information.

4. A parking assistance method comprising:
an odometry information acquisition step of acquiring odometry information indicating a positional change amount and an orientation change amount of a vehicle between a parking space and a first position outside the parking space;
a road surface region identification step of identifying, based on the odometry information, a road surface region of the parking space in a first image captured from the first position by an in-vehicle camera mounted on the vehicle; and
a position and orientation estimation step of calculating, by comparing the road surface region in a second image captured by the in-vehicle camera from a second position different from the first position outside the parking space with the road surface region in the first image, relative position and orientation information indicating a positional change amount and an orientation change amount of the vehicle between the first position and the second position, and outputting, based on the odometry information and the relative position and orientation information, position and orientation estimation information indicating a position and orientation of the vehicle with respect to the parking space when the vehicle is located at the second position.

5. A parking assistance program stored on a non-transitory computer readable medium configured to cause a computer to execute:
an odometry information acquisition step of acquiring odometry information indicating a positional change amount and an orientation change amount of a vehicle between a parking space and a first position outside the parking space;
a road surface region identification step of identifying, based on the odometry information, a road surface region of the parking space in a first image captured from the first position by an in-vehicle camera mounted on the vehicle; and
a position and orientation estimation step of calculating, by comparing the road surface region in a second image captured by the in-vehicle camera from a second position different from the first position outside the parking space with the road surface region in the first image, relative position and orientation information indicating a positional change amount and an orientation change amount of the vehicle between the first position and the second position, and outputting, based on the odometry information and the relative position and orientation information, position and orientation estimation information indicating a position and orientation of the vehicle with respect to the parking space when the vehicle is located at the second position.

6. The parking assistance device according to claim 2, further comprising:
a parking control unit configured to perform control to park the vehicle in the parking space from the second position based on the position and orientation estimation information.
